(19) United States
(12) Patent Application Publication
(10) Pub. No.: US 2019/0039020 A1
(43) Pub. Date: Feb. 7, 2019

(54) METHOD AND APPARATUS FOR SULFUR REMOVAL

(71) Applicant: The Research Foundation for The State University of New York, Albany, NY (US)

(72) Inventors: Devinder MAHAJAN, South Setauket, NY (US); Saurabh U. PATEL, Huntington, NY (US)

(21) Appl. No.: 16/076,388

(22) PCT Filed: Feb. 13, 2017
(86) PCT No.: PCT/US2017/017616

§ 371 Date: Aug. 8, 2018

Related U.S. Application Data
(60) Provisional application No. 62/293,963, filed on Feb. 11, 2016.

(51) Int. Cl. B01D 53/86

(52) U.S. Cl. CPC B01D 53/8612; B01D 2255/20738; B01D 2255/20761; B01D 2258/05; B01D 2255/9202; B01D 2258/0266; B01D 2255/702

(57) ABSTRACT

Provided is a method for removing hydrogen sulfide from a gas stream. The method includes contacting the gas stream with a reactor that is configured to remove the hydrogen sulfide. The reactor includes at least one nano-sized metal.

### PRIORITY

This application claims priority to U.S. Provisional Application No. 62/293,963, filed with the U.S. Patent and Trademark Office on Feb. 11, 2016, the contents of which are incorporated herein by reference.

### GOVERNMENT SUPPORT

This invention was made with government support under grant number 1079498-1-48061 awarded by the National Science Foundation. The government has certain rights in the invention.

### BACKGROUND OF THE INVENTION

### 1. Field of the Invention

The present invention relates to a method and apparatus for removal of impurities from contaminated gas streams.

### 2. Description of the Related Art

Feedstocks, renewable sources, e.g., animal waste, wastewater treatment plants and biogas from landfills are excellent sources from which methane is extracted. Methane is a source of energy, and landfills are the third largest source of methane emissions after agriculture and oil and gas operations. Landfills have the potential to yield eleven billion cubic meters (BCM) or 9.9 million tonnes of oil equivalent methane energy. Given the relatively small size of the methane sources, as compared to fossil methane, a global demand exists to develop economical modular production plants to process the feedstocks to produce power, transportation fuels and chemicals. However, these feedstocks invariably contain sulfur, commonly as hydrogen sulfide (H₂S).

H₂S is a colorless gas with a rotten egg odor at low concentrations. In high concentrations, or with prolonged exposure to low concentrations, H₂S becomes odorless. H₂S is a chemical asphyxiant that can be deadly at sufficiently high concentration or long exposure. At low concentrations (0-10 ppm), symptoms can include irritation of the nose, eyes and throat. At moderate concentrations (10-50 ppm), symptoms can include headaches, dizziness, nausea, coughing and difficulty breathing. At high concentrations (50-200 ppm), symptoms can include shock, convulsions, eye irritation, severe respiratory tract irritation, coma or death.

Table 1 provides physical and chemical properties of H₂S.

TABLE 1

| Molecular formula | H₂S |
|---|---|
| Molecular weight | 34.08 g |
| Vapor pressure | 15,600 mmHg at 25° C. |
| Density | 1.5392 g/L at 0° C., 760 mmHg |
| Boiling point | −60.33° C. |
| Water solubility | 3980 mg/L at 20° C. |
| Dissociation constants | pKa1 = 7.04; pKa2 = 11.96 |
| Conversion factor | 1 ppm = 1.39 mg/m3 |

H₂S is highly flammable. If burned, H₂S generates toxic gases such as sulfur dioxide. Landfill gas can contain up to 1% of H₂S. Typically landfill gas contains much less than 1% H₂S, with H₂S mainly being found in construction and demolition landfills. Releasing landfill gas into the atmosphere without removing H₂S can cause significant health complications to those who live or work near the landfill. Therefore, it is desirable to remove H₂S from gas streams before burning.

Commercially available processes to remove sulfur from landfill gases include SULFUR RITE®, LO-CAT®, Sulfatreat®, and Thiopaq®. These conventional systems remove sulfur, with different corresponding efficiencies and costs. SULFUR RITE® uses an iron sponge with a slight charge. The iron sponge is composed of redwood chips imbued with hydrated iron oxide. However, regular media replacement is necessary and unreacted iron oxide can catch fire when changing out the media. Therefore, SULFUR RITE® uses an inert ceramic base instead of redwood chips.

Sulfatreat® also uses hydrated iron oxide on an inert ceramic base to convert the hydrogen sulfide to iron pyrite. LO-CAT® is a sulfur removal system that uses a regenerable catalyst. The process involves input of landfill gas into an absorber, in which the catalyst removes the hydrogen sulfide from the landfill gas and forms sulfur. The catalyst/sulfur mix then moves into the oxidizer, and catalyst particles are regenerated using air. The mixture then moves into a filter, where the sulfur is separated from the catalyst. The sulfur is collected and the catalyst is returned to the absorber. Thiopaq® is both a sulfur removal system and a sulfur recovery system, in which landfill gas enters the absorbers, H₂S is removed from the gas and converted to sodium sulfides, and the treated landfill gas exits the system. The sodium sulfides then go into a flash vessel or to a bioreactor, depending on the amount of sulfide present. In the bioreactor, the microorganisms oxidize the sulfides to sulfur, and the solution is separated into two streams. Some of the solution moves into a decanter centrifuge to separate the sulfur out, while the remaining solution goes back to the absorber. The sulfur that is recovered is biosulfur, which does not exhibit the hydrophobic properties that sulfur from Claus reactions does, and is used in new agricultural products. Therefore the recovered sulfur can be sold as biosulfur or can be melted down and sold as ‘Claus spec’ sulfur.

Oil and gas operations produce large volume large gas streams, in which liquid based adsorbents are used. See, e.g., U.S. Pat. No. 3,864,460 to Connell, the contents of which are incorporated herein by reference. Connell describes using aqueous solutions monoethanolamine for gas streams in the absence of carbonyl sulfide. Alkanolamines (amines) are water soluble and react reversibly with acid gases such as H₂S. The principle of amine scrubbing is dictated by the reactions in Equation (1):

RNH₂+H₂S⇔RNH³⁺+HS⁻ (1)

The stream is then heated to desorb the acidic components, creating a concentrated gas stream of H₂S, which can then be used in a Claus unit or other unit to be converted to elemental sulfur. This process is preferable for gas from anaerobic digesters See, Nagl, G., Controlling H₂S emissions. Chemical Engineering, 104(3), 125-131 (1997). Amines that are commonly used are monoethanolamine (MEA), diethanolamine (DEA) and methyldiethanolamine (MDEA). Substituted streams are attractive because of the ability to be selective for either H₂S or both CO₂ and H₂S removal, and are regenerable. See, McKinsey Zicarai, S. Removal of hydrogen sulfide from biogas using cow-manure compost. M.S. Thesis, Cornell University, 1-104 (2003).

However, a problem associated with this conventional process is that a portion of the amine gas is either lost or degraded during H₂S removal, and it is expensive and energy intensive to regenerate or replace the solution. Other disadvantages include complicated flow schemes, foaming problems, and restrictions on disposal of foul regeneration air. See, McKinsey Zicarai.

Another conventional process simply uses water scrubbing to remove CO₂ and H₂S from biogas since they are more soluble in H₂O than CH₄. In the water scrubbing process, biogas is pressurized to 150 to 300 psi, and introduced into the bottom of a tall vertical column, while H₂O is introduced from the top flowing downward over a packed bed. The packed bed is typically composed of high surface area plastic media that allow for efficient contact between water and gas phases in a countercurrent absorption regime. The CO₂ and H₂S saturated H₂O exits the column from the bottom. The H₂O in some cases can be regenerated and recirculated back to the column. This is done by depressurizing or stripping with air in a similar column. See, M. Persson, et al., IEA Bioenergy Task 37: Energy from Biogas and Landfill Gas (2006); A. Wellinger, et al., IEA Bioenergy Task 24: Energy From Biological Conversion of Organic Waste (2005); S. Cavenati, et al., Ind. Eng. Chem. Res. 47 (16), 6333-6335 (2008); S. S. Kapdi, et al., Renew Energ. 30 (8), 1195-1202 (2005).

Regeneration and recirculation is not recommended when high levels of H₂S are present in the gas because the contaminated H₂O can damage metal parts. Thus, in many instances a single-pass process with no H₂O regeneration stage is used. An advantage of H₂O scrubbing is the relative simplicity and low cost of the operation. Ninety-five percent CH₄ purity and relatively low CH₄ loss (2%) can be achieved in a single stage process. This type of system is suited for wastewater facilities which have a large amount of free flowing H₂O, but use has declined since its introduction in 1970s. There are number of different techniques that have been developed at the lab scale for removal of H₂S but few have been successfully commercialized. Of those few commercialized techniques, catalytic conversion, hydrosulfurization and filtration through impregnated activated carbon have been successfully utilized. See, Abatzoglou, N., et al. A review of biogas purification processes. Biofuels, Bioproducts and Biorefining, 3(1), 42-71 (2009); Petersson, A., et al., Biogas upgrading technologies—developments and innovations, IEA Bioenergy, 12-15 (2009); Zhao, Q., et al. Purification Technologies for Biogas Generated by Anaerobic Digestion, Washington: CSANR Research Report 2010-001, Compressed Biomethane (2010).

Table 2 summarizes these technologies.

TABLE 2

| Technology | Methodology | Disadvantage |
|---|---|---|
| Chemical absorption in a Fe-chelated solution | ${H}_{2} S + \frac{1}{2} {O}_{2} {\to }^{yields} S + {H}_{2} O$ | Complex and expensive process |
| Chemical adsorption in a | aqueous mixed-metal sulfate | Complex and expensive |
| mixed-metal sulfate solution | solution | process. |
| | | H₂S remova1 = 85-99% |
| Chemical adsorption on a | a Fe oxide-based adsorbent | Limited to one time use for |
| solid adsorbent | | maximum efficiency of 100% |
| Adsorption and oxidation on | Virgin AC | Limited by the loading |
| activated carbon | | capacity of the adsorbent |
| Catalytic oxidation over AC | Impregnated AC as oxidation | Limited by the loading |
| | catalyst | capacity of the adsorbent |

Conventional methods for H₂S removal are limited by adsorption capacity and/or requirement to replace the active media, which limits usage and requires frequent and costly replacement. See, Abatzoglou & Boivin, Biofuels, Bioprod. and Biorefin., 3(1), 42-71 (2009); Petersson & Wellinger, IEA Bioenergy, 12-15 (2009). Moreover, H₂S that is adsorbed in the packed media bed during processing must undergo costly treatment before disposal. The spent adsorbent media requires further costly treatment to manage captured H₂S before recycling or disposal, and a sulfur removal process based on an amine system is excessively complex.

Effective removal of the H₂S from gas streams can be achieved using adsorbents, e.g., activated carbon, that work by adsorption of H₂S in pores and that release heat in an exothermic reaction. Effective removal of the H₂S from gas streams can be achieved using amine based systems that form an adduct with H₂S in an exothermic reaction. The adsorption capacity and moles of amine determines that upon saturation, the system must be replaced with fresh material. Alternatively, in each system, the active material can be regenerated by providing heat to reverse the adsorption process. That is, the spent materials can be regenerated by providing heat that expels the adsorbed H₂S molecule or the decomposition sulfur (S) product. The overall process in the systems is best described as a two-step process. Integration of both steps can be challenging. In commercial systems though, the two-step process is cumbersome in several ways. In order to make an energy efficient system, heat integration, material regeneration or frequent changing of the adsorbent can be challenging and often results in an energy penalty.

Accordingly, a need exists for a more efficient and economical method and system for H₂S removal.

### SUMMARY OF THE INVENTION

The present invention overcomes the limitations of conventional systems and provides a method for removing H₂S from a gas stream, with the method includes contacting the gas stream with a reactor that includes at least one nano-sized metal configured to remove the H₂S. The at least one nano-sized metal of the reactor is heated between approximately 200° C. and 255° C. during removal of the H₂S, and the at least one nano-sized metal is a catalyst. The at least one nano-sized metal is not consumed during the removal of the H₂S, and the at least one nano-sized metal is copper.

Another aspect of the present invention provides a method for removing H₂S from a gas stream, the method including contacting the gas stream with a reactor configured to remove the H₂S, with the reactor including biochar and at least two nano-sized metals, with the at least two nano-sized metals not being consumed during the removal of the H₂S, and unconverted H₂S does not accumulate within the reactor.

A further aspect of the present disclosure provides an apparatus that removes H2S from a gas stream, with the apparatus including a reactor configured to contacting the gas stream and remove the H2S, with the reactor including biochar and at least two nano-sized metals.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a diagram of an H₂S removal unit utilized to perform the examples described herein;

FIG. 2a is a graph of breakthrough curves of four biochar samples at 23° C.;

FIG. 2b is a graph of breakthrough curves of four biochar samples at 100° C.;

FIG. 2c is a graph comparing total H₂S removal capacity of four samples;

FIG. 3 shows output obtained at an outlet of a packed bed reactor of the H₂S removal unit of FIG. 1;

FIG. 4 is a graph showing percentage H₂S output over time from the removal unit using a 2 g nano-iron oxide moderated with 1 g layer of biochar, heated to 200° C.;

FIG. 5 is a graph showing percentage H₂S output over time from the removal unit using a 5 g nano-iron oxide moderated with 1 g layer of biochar, heated to 200° C.; and

FIG. 6 shows output obtained at an outlet of a packed bed reactor of the H₂S removal unit of FIG. 1 for nano-iron oxide and a reactor temperature of 110° C.

### DETAILED DESCRIPTION OF EMBODIMENTS OF THE PRESENT INVENTION

The following detailed description of the preferred embodiments will be made with reference to the accompanying drawings. In the description provided herein, explanation of related functions or constructions known in the art are omitted for the sake of clarity in understanding while avoiding obscuring the concept with unnecessary detail.

A mixed system is provided having the capacity to absorb hydrogen sulfide in a 1:1 mole ratio, i.e., utilizing each available site on the adsorbent and/or absorbent. The adsorbent, e.g., activated carbon, acts as a dispersant. The mixed system contains both the dispersant and a metal oxide. Results of actual runs are described in the following examples, demonstrating efficacy of the combined dispersant and metal oxide.

Aspects of the system are described below utilizing various comparative example runs carried out with dispersant alone, with the dispersant being an adsorbent that by itself is used commercially for H₂S removal. The adsorbent included a commercial sample and a variety of biochars, with four biochars being derived from four sources as examples: hardwood (BC-1), chicken waste and hardwood (BC-2), switchgrass (BC-3), and switchgrass and rye (BC-4).

### Example 1

A Brunauer, Emmett and Teller (BET) surface area of samples of untreated biochar (UBC) produced from all four samples was measured, providing a measured value of less than 0.5 m²/g. Same measurements were repeated for samples BC-2, BC-3 and BC-4, with BET measurement values of less than 0.5 m2/g for each of these three samples. Scanning electron microscopy (SEM) imaging showed presence of alkali salts, including Na, Cl, and K on the surface of all biochar samples.

### Example 2

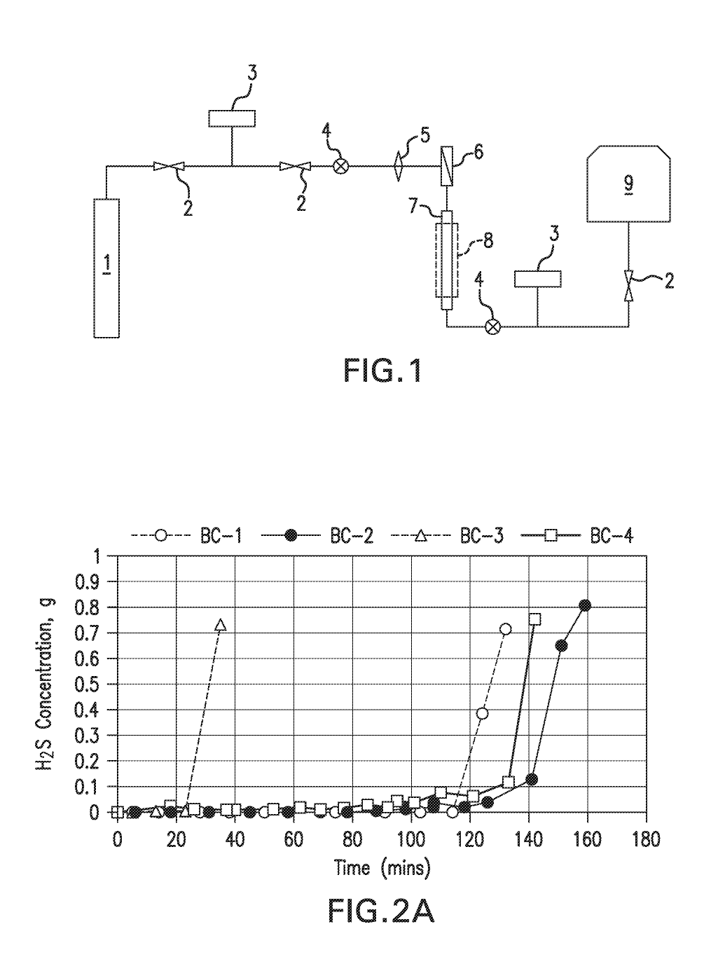

An untreated hardwood biochar adsorbent was tested for H₂S removal efficiency, using the laboratory scale H₂S removal unit shown in FIG. 1, which is a diagram of an H₂S removal unit utilized to perform the examples described herein.

As shown in FIG. 1, a packed-bed reactor 7 is provided, with the packed-bed reactor 7 being a quartz tube of 0.63 cm O.D. and 16.5 cm length. As shown in FIG. 1, synthetic biogas is provided from vessel 1, the synthetic biogas passes a first valve 2a, and a first pressure of the synthetic biogas is displayed on first pressure display 3a. The synthetic biogas passes a second valve 2b, flows through a first sample port 4a, past a needle valve 5 and a flow meter 6, and into a packed bed reactor 7 that is heated by a heater 8. The synthetic biogas then flows past a second sample port 4b, and a second pressure is displayed at a second pressure display 3b. The synthetic biogas then flows past a third needle valve into a gas chromatograph.

In a typical run, 0.6 g-1.8 g adsorbent sample BC-1 was placed in the packed bed reactor. A premixed gas of composition 59% CH₄/40% CO₂/1% H₂S was flowed through the reactor with a gas-hourly-space-velocity (GHSV) of 275 h⁻¹. The entering and exiting gas were analyzed using gas chromatography. The measured H₂S removal capacity of UBC-1 was 0.006 g H₂S/g UBC at 100° C.

### Example 3

The UBC-1 was replaced with UBC-2 and the biochar adsorbent sample was tested for H₂S removal efficiency under the conditions listed in Example 2. The gas chromatographic analysis established the H₂S removal capacity to be 0.005 g/g at 100° C.

### Example 4

The UBC-1 was replaced with UBC-3 and the biochar adsorbent sample was tested for H₂S removal efficiency under conditions listed in Example 2. The gas chromatographic analysis established the H₂S removal capacity to be 0.006 g/g at 100° C.

### Example 5

The UBC-1 was replaced with UBC-4 and the biochar adsorbent sample was tested for H₂S removal efficiency under conditions listed in Example 2. The gas chromatographic analysis established the H₂S removal capacity to be 0.006 g/g at 100° C.

### Example 6

A sample of biochar produced from hardwood was oxidized under CO₂ at 900° C. for 60 minutes. The sample was cooled to room temperature under flowing CO₂, and the same treatment was repeated for samples BC-2, BC-3 and BC-4. The BET measurements gave values of 1026, 506, 433 and 344 m2/g, respectively for the four samples confirming a large increase in SA for the samples. Examples 7-11 show the effect of biochar activation on H₂S removal capacity.

### Example 7

The activated biochar (ABC) sample was tested for H₂S removal efficiency using the laboratory scale H₂S removal unit shown in FIG. 1. In a typical run, 0.6 g-1.8 g activated adsorbent hardwood based sample ABC-1 was placed in the packed bed reactor. A premixed gas of composition 59% CH₄/40% CO₂/1% H₂S was flowed through the reactor with a gas-hourly-space-velocity (GHSV) of 275 h⁻¹. The entering and exiting gas was analyzed using gas chromatography. The measured H₂S removal capacity was 0.097 g/g at 23° C.

### Example 8

ABC-2 was replaced and the biochar adsorbent sample was tested for H₂S removal efficiency under conditions listed in Example 7. The gas chromatographic analysis established the H₂S removal capacity to be 0.057 g/g at 23° C.

### Example 9

The biochar sample ABC-1 was replaced with ABC-3 and the biochar adsorbent sample was tested for H₂S removal efficiency under conditions listed in Example 7. The gas chromatographic analysis established the H₂S removal capacity to be 0.035 g/g at 23° C.

### Example 10

The biochar sample ABC-1 was replaced with ABC-4 and the biochar adsorbent sample was tested for H₂S removal efficiency under conditions listed in Example 7. The gas chromatographic analysis established the H₂S removal capacity to be 0.050 g/g at 23° C.

### Example 11

The biochar sample ABC-1 was replaced with commercial activated carbon (SA=1100 m²/g) and the sample was tested for H₂S removal efficiency under conditions listed in Example 7. The gas chromatographic analysis established the H₂S removal capacity to be negligible at 23° C.

Examples 12-16 show the effect of increased temperature on H₂S removal capacity of the adsorbent, with temperature increased from 23° C. to 100° C.

### Example 12

With conditions the same as in Example 7 and with biochar sample ABC-1, the test temperature was raised to 100° C. The gas chromatographic analysis established the H₂S removal capacity to be 0.059 g/g at 100° C. from 0.097 g/g at 23° C. The decrease in capacity is attributed to an increased desorption at a higher temperature.

### Example 13

With conditions the same as in Example 7 and with biochar sample ABC-2, the test temperature was raised to 100° C. The gas chromatographic analysis established the H₂S removal capacity to be 0.038 g/g at 100° C. from 0.057 g/g at 23° C., similar to that observed with ABC-1.

### Example 14

With conditions the same as in Example 7 and with biochar sample ABC-3, the test temperature was raised to 100° C. The gas chromatographic analysis established the H₂S removal capacity to be 0.047 g/g at 100° C. from 0.035 g/g at 23° C.

### Example 15

With conditions the same as in Example 7 and with biochar sample ABC-4, the test temperature was raised to 100° C. The gas chromatographic analysis established the H₂S removal capacity to be 0.036 g/g at 100° C. from 0.050 g/g at 23° C.

### Example 16

With conditions the same as in Example 11 and with the same commercial activated carbon sample, the test temperature was raised to 100° C. The gas chromatographic analysis established the H₂S removal capacity to be 0.033 g/g at 100° C. from 0.0 g/g at 23° C.

Examples 1-16 show that the biochar serves as an adsorbent and is effective for H₂S removal from a gas flow that contains 1% H₂S. However, such systems are not very efficient because, once saturated, the packed bed must be either replaced or readied for reuse. If replaced, the packed bed must be disposed of most likely in a landfill, which is challenging. Alternatively, for reuse, the bed is heated to drive out the adsorbed H₂S in a separate step, making the process more cumbersome. Either way, an energy penalty is realized.

Examples 2-5 show that untreated biochar, i.e., the UBC samples, with SA of less than 0.5 m²/g has very low efficiency for H₂S removal, ranging from 0.005-0.006 g/g. When the UBC samples were activated, the SA increased from 394-1026 m²/g, and the corresponding H₂S removal efficiency also increased dramatically. In examples 7-11 at 23° C., the H₂S removal values for ABC samples were 0.035-0.097 m²/g. When the temperature increased to 100° C. in examples 12-15, the values ranged from 0.036-0.059 m²/g. The values for ABC samples were higher when compared to a commercial activated carbon sample (SA: 1100 m²/g) for which the values were zero and 0.033 m2/g. Accordingly, the overall performance of biochar is better than commercial activated carbon for H₂S removal. Thus, examples 2-16 provide baseline runs with non-activated and activated adsorbent based treatments to identify an adsorbent usable for a hybrid process that combines a two-step process into a one-step process that allows continuous H₂S adsorption and subsequent decomposition on the same bed; and catalytic decomposition that allows bed volume to shrink from 22.4 liters to 32 g when H₂S continually decomposes to H₂ and yellow sulfur (S₈). The hybrid process avoids frequent bed replacement, is more environmentally efficient and is more economical.

A metal oxide is used as the basic catalyst, with the metal oxide selected from metals that that are known to show stoichiometric (not catalytic) H₂S removal property. Also, the catalyst is nano-sized, as described in the following examples.

### Example 17

Nano-sized metal oxides precursors were prepared from commercially available precursors, and metals were selected from copper, nickel, iron, cobalt, and other metals using a sonicator, e.g., Misonix model 2020 with 600 watts power, to provide fixed frequency sound waves that are used to break bonds to produce nano-sized metal particles, with particles as small as less than 10 nm.

For the sonolysis, a tapered four-necked borosilicate glass flask was used to allow maximum solution in the middle of the flask for adequate immersion of the sonication probe. A series of O-rings and standard greased ground-glass joints ensured tight seals to maintain rigorous exclusion of air or gas leakage from the flask during sonication. A gas collection set-up quantified any gas evolved during sonication by collection and analysis. A bath was used to immerse the flask to maintain a constant temperature.

In a run of the cobalt system, a 0.2 g CO₂(CO)₈ precursor was added to 50 mL n-decane as a solvent and the resulting slurry was thoroughly degassed with argon or nitrogen. The degassed solution was then sonicated at 100% intensity and 80% pulsed cycle settings. Sonication of the solution resulted in gas formation which was collected and analyzed. Within minutes of starting the sonication the solution turned into a black slurry and the gas started to evolve, with a theoretical carbon monoxide (CO) evolution as 5 mole times the added cobalt. When gas evolution ceased, the black product was centrifuged and the upper solvent layer was decanted to separate the product. The remaining black solid was washed three times with n-hexane to remove any residual solvent. The process of sonication allows cleavage of metal-carbon bonds in the metal precursor and results in nano-sized metal particles.

### Example 18

The cobalt precursor was replaced by 0.015 mol iron pentacarbonyl, a yellow homogeneous formed and the same procedure was followed. The theoretical CO was 0.075 mol. After 8 hours, 90% reaction was complete. After the work-up, a black powder was produced. Transmission Electron Microscopy (TEM) of the black powder showed that the particles were less than 10 nm size. The X-ray Diffraction (XRD) spectrum of the sample matched well with that of Fe₃O₄ (magnetite). In other cases, the reaction time was varied from 2 hours to 8 hours.

### Example 19

The cobalt precursor was replaced by 0.015 mol Ni tetracarbonyl, a colorless homogeneous formed and the same procedure was followed, taking care when handling due to the high toxicity of the nickel carbonyl complex. The theoretical CO was 0.060 mol. After 15 minutes, greater than 90% reaction was complete. After the work-up, a black powder was produced. The TEM of the black powder showed that the particles were 10-20 nm in size and the XRD spectrum of the sample matched well with that of NiO.

### Example 20

The cobalt precursor was replaced by 0.015 mol copper chloride or acetate, a green hue homogeneous solution formed and the same procedure was followed. After about four hours, greater than 90% reaction was complete.

Examples 17-20 show production of nano-sized particles of metals using sonication in which a black product was produced. The spectroscopic measurements showed that:
1) particles with surface area ranging from 195-34 m² g⁻¹ were produced when using n-decane, while surface areas ranging from 76-16 m² g⁻¹ were produced using hexadecane;
2) sonication time between 2-3 hours led to particles of 100-200 nm in diameter and 4-8 hours led to particles of greater than 30 nm in diameter;
3) increasing sonication time from four hours to eight hours resulted in 25% and 8% increase in surface area of particles produced in n-decane and hexadecane, respectively; and
4) the reaction processed at a lower rate in n-decane than hexadecane, thus resulting in lower product yield.

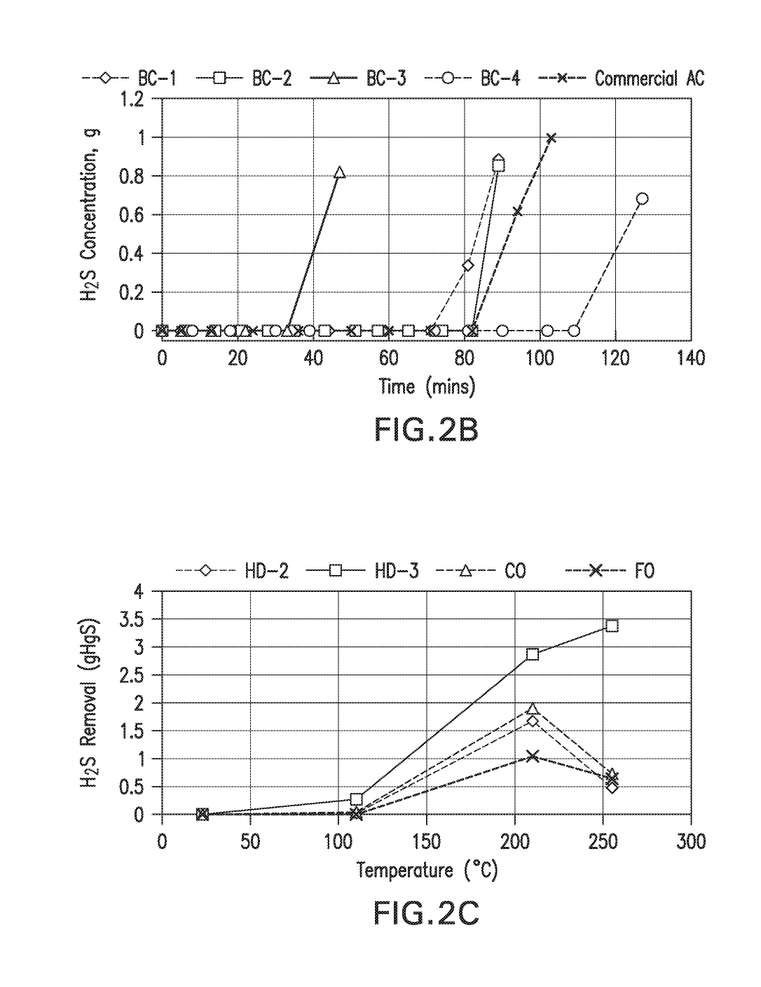

The following examples show sulfur removal performance of the prepared nano metals. The examples generally involved packing nano metal as a packed bed in a glass tube, and plugging both sides of the tube with glass wool to avoid aerosoling that would otherwise result in a slow material loss from the packed bed. The impure gas containing H₂S was then flowed through the tube and the gas was analyzed before and after passing through the bed. The data were used to plot breakthough curves provided in FIGS. 2a-2c, and establish the nanometal catalytic properties.

FIG. 2a is a graph of four biochar samples at 23° C., FIG. 2b is a graph of four biochar samples at 100° C., and FIG. 2c is a graph comparing total H₂S removal capacity of four samples. FIG. 2c compares total H₂S removal capacity by nano-sized iron oxide (HD-2), nano-sized iron oxide (HD-3), CO, and iron oxide (FO) samples. The HD-2 and HD-3 samples are differentiated by two and three hours of sonication, yielding surface areas of 16.5 and 53.7 m² g⁻¹, respectively.

### Example 21

H₂S removal was conducted in the unit of FIG. 1 with a packed-bed reactor of 0.63 cm diameter and 16.5 cm. The commercial copper oxide catalyst (0.2-2.0 g) was filled in the center (2.28 cm) and the reactor was plugged with glass wool on both sides to ensure that there was no catalyst attrition when the impure gas was flowing through the reactor. The reactor temperature was set at 23° C. The gas mixture (CH₄: 59%; CO₂: 40%; H₂S: 10,000 ppm) was started through the reactor and the gas hourly space velocity was maintained at 1690 h⁻¹. The breakthrough curve showed the same H₂S concentration as initial (10,000 ppm) indicating total inactivity.

### Example 22

Copper oxide (CO) is used and the temperature of the reactor was raised to 110° C., and the setup and other conditions of Example 21 were maintained. As shown in FIG. 2c, no H₂S appeared at the outlet for 60 min when 100 ppm H₂S was measured. The total H₂S removal was 0.02 g/g catalyst, indicting activity in comparison to the peak 0.097 g/g biochar (ABC) of Example 7.

### Example 23

The temperature of the reactor was raised to 210° C., and the setup and other conditions of Example 21 were maintained, and the H₂S concentration at the outlet was not measured for 65 hours. As shown in FIG. 2c, the total H₂S removed was 1.91 g/g catalyst for commercial micron-sized copper oxide (CO), indicting activity in comparison to the activity of ABC sample in Example 7, with the activity of copper being higher by a factor of at least 19.

### Example 24

The temperature of the reactor was raised to 255° C., and the setup and other conditions of Example 21 were maintained. As shown in FIG. 2c, the same H₂S concentration at the outlet decreased, with the total H₂S removal was 0.73 g/g catalyst, indicating high activity.

### Example 25

The catalyst was changed to micron-sized nickel oxide, and all other conditions of Example 21 were maintained, showing the same H₂S concentration as initial (10,000 ppm), indicating total inactivity.

### Example 26

The catalyst was changed to nano-sized nickel oxide and the reactor temperature was maintained at 23° C., and all other conditions of Example 21 were maintained. The same H₂S concentration was shown as initial (10,000 ppm), indicating total inactivity.

### Example 27

The reactor temperature was maintained at 110° C., and all other conditions of Example 25 were maintained. The same H₂S concentration was shown as initial (10,000 ppm), indicating total inactivity.

### Example 28

The reactor temperature was raised and maintained at 210° C., and all other conditions of Example 25 were maintained. The same H₂S concentration was shown as initial (10,000 ppm), indicating total inactivity.

### Example 29

The reactor temperature was raised and maintained at 255° C., and all other conditions of Example 25 were maintained. The same H₂S concentration was shown as initial (10,000 ppm), indicating total inactivity.

### Example 30

The catalyst was changed to nano-sized iron oxide (HD-2) with a mean particle diameter (MPD) less than 10 nm, and all other conditions of Example 21 were maintained. At the reactor temperature of 23° C., the breakthrough curves showed an H₂S concentration at the outlet being the same, indicating that the catalyst was inactive.

### Example 31

For a nano-iron oxide catalyst with a surface area (SA) of 16.5 m²/g, the temperature of the reactor was raised to 110° C., and all other conditions of Example 21 were maintained. The breakthrough curves showed an H₂S concentration at the outlet of 1136 ppm after 40 minutes, with a total H₂S removal of 0.03 g/g catalyst, indicating some activity.

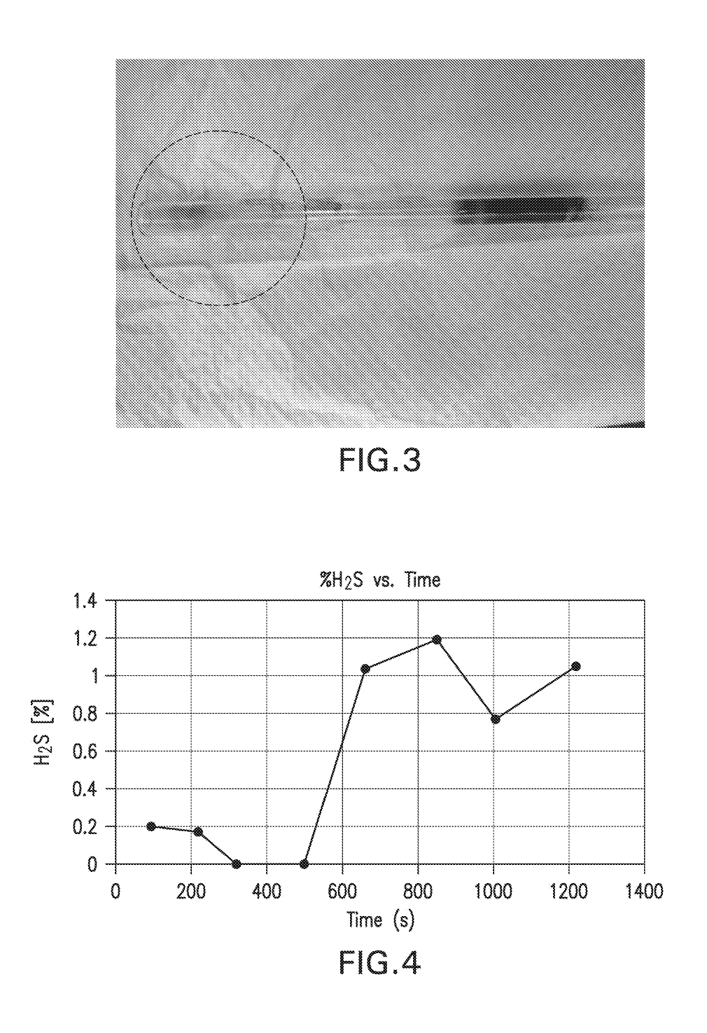

FIG. 3 shows output obtained at an outlet of a packed bed reactor of the H₂S removal unit of FIG. 1. The circle 210 of FIG. 3 shows formation of a yellow color, i.e., sulfur removed from the H₂S stream, output at the top of the reactor. The yellow color indicates accumulation of sulfur removed from the gas stream.

### Example 32

A quartz tube 61 cm in length and 2.34 cm O.D. was filled with 2 g nano-iron oxide (magnetite) and moderated with 1 g layer of biochar, then heated to 200° C. The gas velocity of simulated landfill gas containing 1% H₂S passed through the quartz tube filled iron at 100 mL/min. The time-resolved H₂S exiting the tube was measured, with the results of the measurement being shown in FIG. 4.

FIG. 4 is a graph showing percentage H₂S output over time from the removal unit using a 2 g nano-iron oxide moderated with 1 g layer of biochar, heated to 200° C. The total H₂S removal was 0.0312 mol H₂S, indicating that the mixture of Example 32 is far more effective than the adsorbent in Example 12.

### Example 33

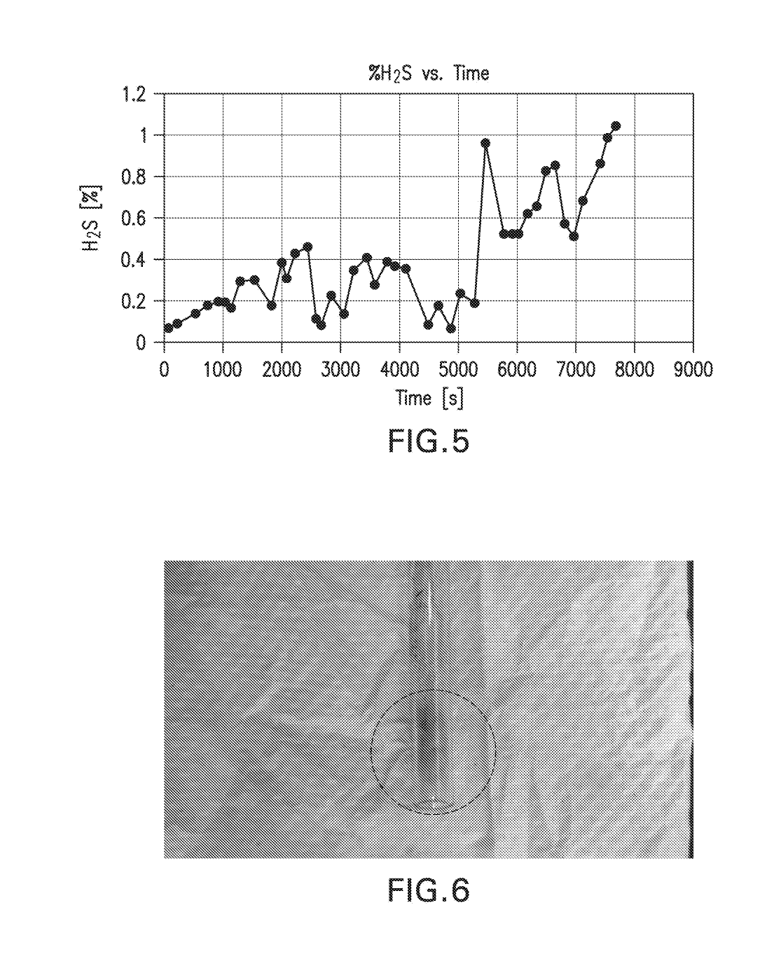

Example 32 was scaled up to 5 g iron oxide filled in the quartz tube and then moderated with biochar. The gas velocity of simulated gas composition similar to Example 35, with the gas stream increased to 1544 mL/min, maintaining the other conditions of Example 21. The time-resolved exit H₂S gas measurement is shown in FIG. 5, which is a graph showing percentage H₂S output over time from the removal unit using a 5 g nano-iron oxide moderated with 1 g layer of biochar, heated to 200° C.

The run of Example 33 lasted more than two hours at the increased high gas velocity before the catalyst became ineffective. A total of 0.339 g H₂S was removed, indicating that 2.30 mol H₂S per mole of Fe was removed. The data establishes that the reaction is catalytic as the removed S was 2.3 times the amount of iron added.

### Example 34

Nano-iron oxide having an SA of 53.2 m2/g was used, and the temperature of the reactor was raised to 110° C., keeping other set-up and reaction conditions of Example 21 maintained.

The breakthrough curves show the H₂S concentration at the outlet after 64 minutes, with a total H₂S removal of 0.27 g/g catalyst, indicating some activity.

FIG. 6 shows output obtained at an outlet of a packed bed reactor of the H₂S removal unit of FIG. 1, based on example 34. As shown in FIG. 6, yellow color forms at the top of the reactor (see circle), which is elemental sulfur (S8) formed by the decomposition of H₂S.

### Example 35

A nano-iron oxide catalyst (SA: 53.2 m²/g) was used, the temperature of the reactor was raised to 210° C., and the other conditions of Example 34 were maintained. The breakthrough curves showed no H₂S concentration at the outlet for 33 hours. The total H₂S removal was 3.87 g/g catalyst, indicating high activity. For reference, the highest number was 0.097 g/g biochar (ABC) in Example 7. Comparing Example 7 with Example 35 shows an increase in activity by a factor of thirty-nine, indicating that the H₂S removal is catalytic in iron catalyst, and a yellow sulfur deposit was observed at the outlet.

### Example 36

A nano-iron oxide catalyst (SA: 53.2 m²/g) was used, the temperature of the reactor was raised to 255° C., and the other conditions of Example 34 were maintained. The breakthrough curves showed no H₂S concentration at the outlet for 65 hours. The total H₂S removal was 3.38 g/g catalyst, indicating high activity. Comparing Example 7 to Example 36 shows an increase in activity by a factor of at least thirty-four, and a yellow elemental sulfur (S8) was seen and the H₂S removal was catalytic in iron oxide.

### Example 37

A nano-iron oxide (SA: 16.5 m²/g) was used, the temperature of the reactor was raised to 210° C., and the other conditions of Example 34 were maintained. The breakthrough curves showed no H₂S at the outlet for 21 hours. The total H₂S removal was 1.67 g/g catalyst, indicating high activity. Comparing Example 7 to Example 37 shows an increase in activity by a factor of at least seventeen, though less than that seen at 210° C.

### Example 38

A nano-iron oxide (SA: 16.5 m²/g) was used, the temperature of the reactor was raised to 255° C., and the other conditions of Example 34 were maintained. The breakthrough curves showed the H₂S concentration at the outlet decreased. The total H₂S removal was 0.48 g/g catalyst, indicating high activity. Comparing Example 7 to Example 37 shows an increase in activity by a factor of at least five, though less than that seen at 210° C.

Accordingly, disclosed is a method for removing H₂S from a gas stream, the method including contacting the gas stream with a reactor configured to remove the H₂S, with the reactor comprises at least one nano-sized metal. In the method, at least one nano-sized metal of the reactor is heated between approximately 200° C. and approximately 255° C. during the removal of the H₂S. Also, the at least one nano-sized metal acts as a catalyst during the removal of the H₂S, and the H₂S is decomposed on a surface of the catalyst, and the decomposition produces hydrogen (H₂) and S, with the S being removed from the reactor by sublimation, and not remaining in the reactor.

In the method, the at least one nano-sized metal is not consumed during the removal of the H₂S, and the at least one nano-sized metal is copper or iron. An amount of the H₂S that is removed from a gas stream is 2.3 times an amount of the iron in the reactor and the iron acts as a catalyst for at least seven cycles during the removal of the H₂S, when heated to approximately 210° C. The iron acts as a catalyst for at least six cycles during the removal of the H₂S, when heated to approximately 255° C.

Also provided is a method for removing H₂S from a gas stream that includes contacting the gas stream with a reactor configured to remove the H₂S, with the reactor including biochar and at least two nano-sized metals. The at least two nano-sized metals are not consumed during the removal of the H₂S, and unconverted H₂S does not accumulate within the reactor. The at least two nano-sized metals are copper and iron, and the at least two nano-sized metals of the reactor are heated between approximately 200° C. and approximately 255° C. during the removal of the H₂S, with the at least two nano-sized metals acting as a catalyst during the removal of the H₂S. The H₂S is decomposed on a surface of the catalyst, and the decomposition produces H₂ and S, with the S being removed from the reactor by sublimation, and the S does not remain in the reactor.

Also provided is an apparatus for removing H₂S from a gas stream, with the apparatus including a reactor that contacts the gas stream and remove the H₂S, and the reactor includes biochar and at least two nano-sized metals.

While the disclosed method and apparatus have been shown and described with reference to certain exemplary embodiments thereof, it will be understood by those skilled in the art that various changes in form and details may be made therein without departing from the spirit and scope of the present invention as defined by the appended claims and equivalents thereof.

What is claimed is:

1. A method for removing hydrogen sulfide (H₂S) from a gas stream, the method comprising:
contacting the gas stream with a reactor configured to remove the H₂S,
wherein the reactor comprises at least one nano-sized metal.

2. The method of claim 1, wherein the at least one nano-sized metal of the reactor is heated between approximately 200° C. and approximately 255° C. during the removal of the H₂S.

3. The method of claim 1, wherein the at least one nano-sized metal acts as a catalyst to remove the H₂S.

4. The method of claim 3, wherein the H₂S is decomposed on a surface of the catalyst, and the decomposition produces hydrogen (H₂) and Sulfur (S).

5. The method of claim 4, wherein the S is removed from the reactor by sublimation, and a substantial amount of the S does not remain in the reactor.

6. The method of claim 1, wherein the at least one nano-sized metal is not consumed during the removal of the H₂S.

7. The method of claim 1, wherein the at least one nano-sized metal is copper.

8. The method of claim 1, wherein the at least one nano-sized metal is iron.

9. The method of claim 8, wherein an amount of the H₂S removed from a gas stream is at least two times an amount of the iron in the reactor.

10. The method of claim 8, wherein the iron acts as a catalyst for at least seven cycles during the removal of the H₂S, when heated to approximately 210° C.

11. The method of claim 8, wherein the iron acts as a catalyst for at least six cycles during the removal of the H₂S, when heated to approximately 255° C.

12. A method for removing hydrogen sulfide (H₂S) from a gas stream, the method comprising:
contacting the gas stream with a reactor configured to remove the H₂S,
wherein the reactor comprises biochar and at least two nano-sized metals.

13. The method of claim 12, wherein the at least two nano-sized metals are not consumed to remove the H₂S.

14. The method of claim 12, wherein a substantial amount of unconverted H₂S does not accumulate within the reactor.

15. The method of claim 12, wherein the at least two nano-sized metals are copper and iron.

16. The method of claim 12, wherein the at least two nano-sized metals of the reactor are heated between approximately 200° C. and approximately 255° C. during the removal of the H₂S.

17. The method of claim 12, wherein the at least two nano-sized metals act as a catalyst to remove the H₂S.

18. The method of claim 17, wherein the H₂S is decomposed on a surface of the catalyst, and the decomposition produces hydrogen (H₂) and Sulfur (S).

19. The method of claim 18, wherein the S is removed from the reactor by sublimation, and a substantial amount of the S does not remain in the reactor.

20. An apparatus for removing hydrogen sulfide (H₂S) from a gas stream, the apparatus comprising:
a reactor configured to contacting the gas stream and remove the H₂S,
wherein the reactor comprises biochar and at least two nano-sized metals.
